(19) United States
(12) Patent Application Publication
(10) Pub. No.: US 2016/0039660 A1
(43) Pub. Date: Feb. 11, 2016

(54) Saddle tree for a saddle

(71) Applicant: Mayrhofer & Praher OG, Lichtenberg (AT)

(72) Inventor: Michaela MAYRHOFER, Lichtenberg (AT)

(73) Assignee: Mayrhofer & Praher OG, Lichtenberg (AT)

(21) Appl. No.: 14/819,781

(22) Filed: Aug. 6, 2015

(30) Foreign Application Priority Data
Aug. 5, 2014 (EP) 14179946.0

(51) Int. Cl. B68C 1/02

(52) U.S. Cl. CPC B68C 1/025

(57) ABSTRACT

A saddle tree for a saddle, especially a Western saddle, has a fork, a cantle and with two rigid bars, which are joined to one another via the fork and cantle and each of which has not only at least one positive curvature but also a twist on the underside along its centerline in a longitudinal direction. In order to distribute the weight of the rider over the surface of the horse's back and nevertheless permit adequate shoulder freedom for the horse, the bars are each positively curved along their centerline in a longitudinal direction from the front bar end to the rear attachment of the fork, then are curvature-free or negatively curved up to the front attachment of the cantle and then are positively curved up to the rear bar end.

The invention relates to a saddle tree for a saddle, especially Western saddle, with a fork, a cantle and with two rigid bars, which are joined to one another via fork and cantle and each of which has not only at least one positive curvature but also a twist on the underside along its centerline in longitudinal direction.

U.S. Pat. No. 6,263,647 discloses a saddle tree for a Western saddle with two bars, which are joined in the region or their front end via the fork and in the region of their rear end via the cantle. For the fitting shape of the saddle tree on the horse's back, the bars have in longitudinal direction a curvature, which in the language of the art is known as rock. This rock usually has a continuously positive curvature. In addition, the bars are contorted in longitudinal direction, in order to be able to conform to the shape of the horse's back. This contortion is known in the language of the art as twist. In order to achieve the best possible fitting shape even during the movement of the horse, the bars in U.S. Pat. No. 6,263,647 are made of flexible rubber. It has proved disadvantageous for the riding, however, that the flexible bars do not distribute the weight of the rider very well, which is associated with the known hazards such as muscle, joint, cartilage and nerve damage for the horse. In addition, the shoulder freedom for the horse usually is not provided adequately despite the flexible bars.

The task underlying the invention is therefore, starting from the prior art depicted in the introduction, to improve a saddle tree to the effect that the weight of the rider is distributed over the surface of the horse's back, although the saddle tree still permits sufficient shoulder freedom for the horse.

The invention achieves the stated task by the fact that the bars are each positively curved along their centerline in longitudinal direction from the front bar end to the rear fork attachment, then are curvature-free or negatively curved up to the front cantle attachment and then are positively curved up to the rear bar end.

If the bars are each positively curved along their centerline in longitudinal direction from the front bar end to the rear fork attachment, this may provide for an adequate shoulder freedom, since the horse's shoulder can slide under the front end of the bars during motion. An advantageous transmission of the rider's weight to the horse's back can be achieved when the bars are then curvature-free or negatively curved from the rear fork attachment up to the front cantle attachment. If then the further course of the bars along the centerline in longitudinal direction is positively curved up to the rear bar end, an advantageous fitting shape can be additionally achieved in the region of the end of the thoracic spine. The resulting rock with positive curvature, followed by negative or no curvature as well as followed by positive curvature, is able during collected motion of the horse to transmit the load of the rider optimally to the horse's back. This is precisely what a continuously positively curved rock, corresponding to the prior art, cannot ensure. Only the curvature-free or negatively curved shape of the bars between fork attachment and cantle in longitudinal direction can represent precisely a fitting shape as favorable as possible on the horse's back during collected motion and thus permit a distribution of the weight of the rider over the surface of the horse's back. In contrast, the positive curvature in the region of the bar ends can provide a good shoulder freedom at the front end and a good adaptation to the horse's back at the rear end of the bars. In this way a saddle tree according to the invention for the Western riding can permit an advantageous weight distribution of the rider over a surface and also an adequate shoulder freedom of the horse during the riding.

In general, it is pointed out that curvature can be understood as the local deviation of a curve from a straight line or as the tangent. The curvature of the centerline of the support surface of the bars in longitudinal direction may be of special interest in the course of this application, where the centerline from the front to the rear bar end is followed for the consideration of the local deviation. In this context, a positive curvature can mean a deviation to the left and a negative curvature a deviation to the right. In a saddle fastened for appropriate use, the positive curvature can mean a deviation toward the rider and a negative curvature a deviation in horse direction. For the description of the type of curvature, the point on the centerline that is located closest to the frontmost outer point of the cantle can then be understood as the front attachment of the cantle.

The foregoing advantages can be further improved when the curvature from the front bar end to the rear fork attachment has a steadily increasing radius of curvature. By virtue of this type of curvature, the shoulder is able—among other factors in cooperation with the twist of the bars, which is outward, i.e. turned away from the horse—slide under the saddle tree even in the case of an overlapping of the front bar ends with the shoulder region of a horse. In this way, therefore, it is neither hindered nor blocked during its motion.

Thus if the curvature from the front cantle attachment up to the rear bar end has a steadily decreasing radius of curvature, the saddle tree can permit the horse sufficient freedom of motion in the region of the rear saddle end.

If the saddle tree has two flexible tightening elements, especially straps, which are respectively fastened to a bar in its front and rear bar region and each of which carries a fastening element loosely mounted on the respective tightening element for attachment to a saddle cinch, this can permit an advantageous fastening of the saddle on the horse via the saddle tree.

This can be further improved when the top edge of the flexible tightening element runs up to the front fork attachment and the bottom edge runs up to the front cantle attachment. In the interaction with the loose mounting of the fastening element, the position for the cinching of the saddle can be adjusted in such a way that the fastening element comes to lie under the rear fork attachment. Tightening elements disposed in this way can be excellent in the transmission of the rider's weight to the horse's back by virtue of their special arrangement.

Improvements in load distribution and guidance of the flexible tightening elements can be achieved when the flexible tightening elements are fastened on the bar at its end in the region of the front fork attachment and its other end in the region of the front cantle attachment.

If at least part of the fastening element is located vertically underneath the rear fork attachment, the transmission of the rider's weight to the horse's back can take place particularly uniformly.

This can be further improved when a D-ring forms the fastening element. In particular, the flat part of the D-ring can be guided advantageously along the flexible tightening element, especially a strap, which can be useful to the loose mounting of the D-ring.

If the D-ring has a web, wherein the D-ring forms a slot for passing the respective flexible tightening element between its flat part and the web, the D-ring can be guided on the flexible tightening element, especially a strap, without having to worry about any twisting of tightening element or D-ring. A simply displaceable and nevertheless reliable guidance of the fastening element is therefore possible.

The saddle tree according to the invention can be used as the structure for a saddle.

The saddle may be further characterized with a skirt, wherein the web of the D-ring projecting in part from the skirt is disposed above the bottom edge of the skirt. This can further improve the transmission of the rider's weight to the thoracic spine of the horse.

As is known, the saddle can be fastened onto the horse with a saddle cinch, which is attached to the fastening element.

In general, it is pointed out that a saddle tree in which the front bar end is constructed so as to be set back relative to the fork can provide advantages in terms of shoulder freedom of the horse.

By way of example, the subject matter of the invention will be illustrated in more detail on the basis of an alternative embodiment in the figures, wherein

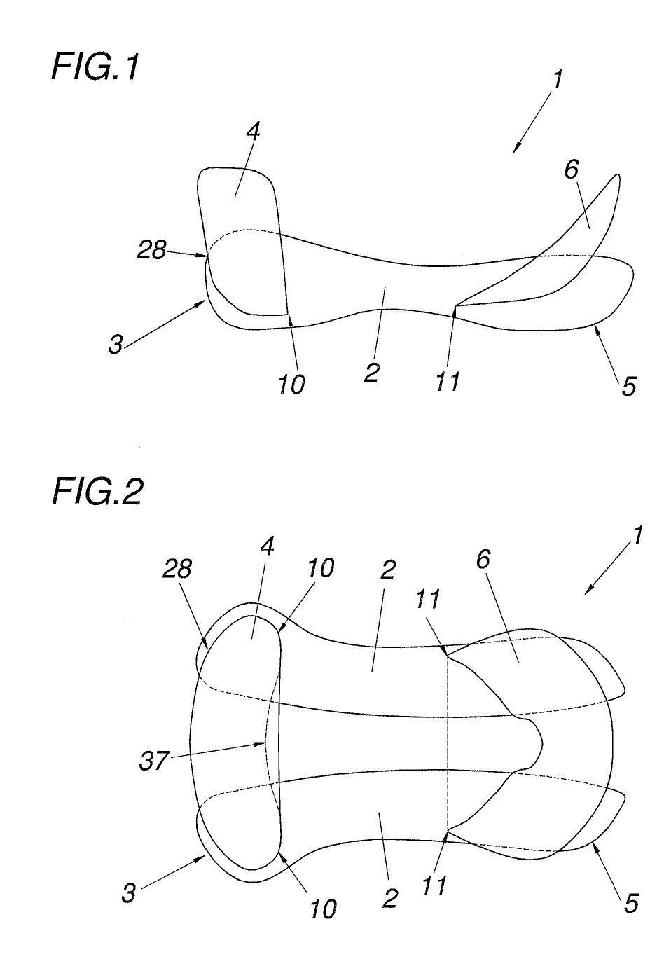

FIG. 1 shows a side view of the saddle tree,

FIG. 2 shows a plan view of the saddle tree,

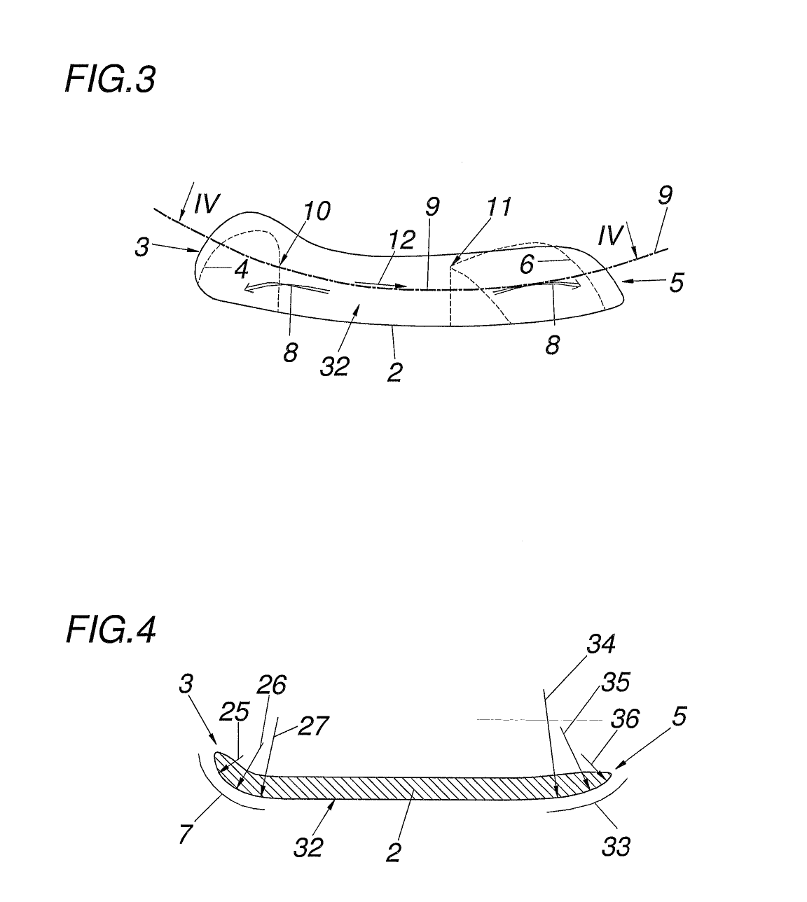

FIG. 3 shows an elevation view of the support surface of a bar of the saddle tree,

FIG. 4 shows a profile of the bar along the centerline in longitudinal direction according to FIG. 3 and

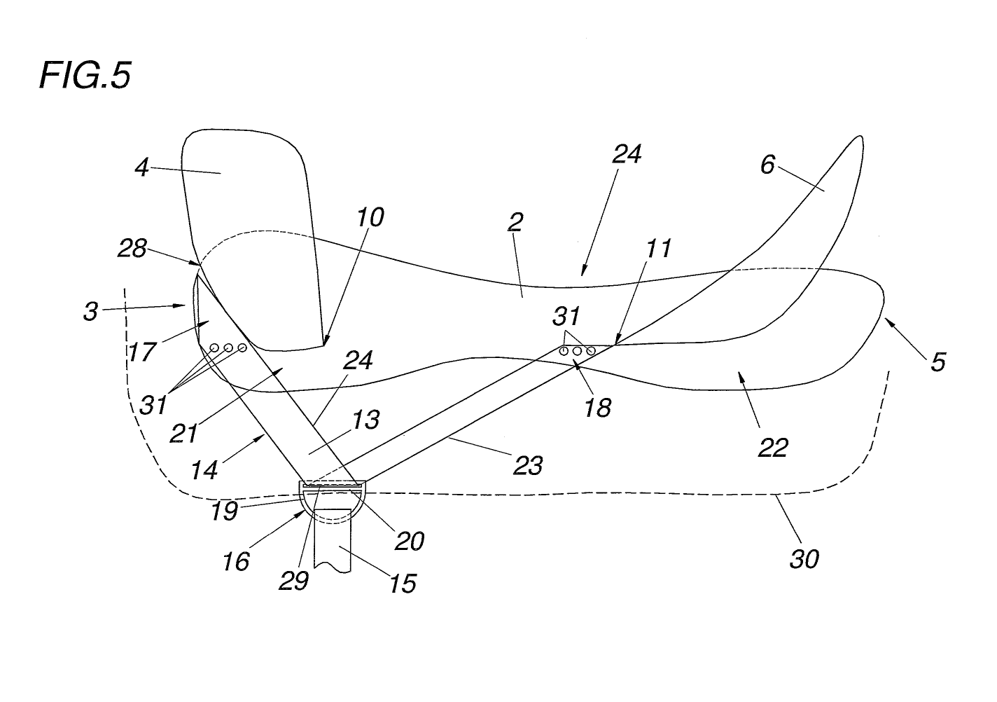

FIG. 5 shows a side view of the saddle tree with flexible tightening element for attachment of a saddle cinch.

For example, a side view of an exemplary saddle tree 1 for a Western saddle, not illustrated in more detail, is shown according to FIG. 1 and the corresponding plan view is shown in FIG. 2. As is evident from the figures, the saddle tree 1 has two bars 2. As viewed in the direction of the horse's head, these are joined in the region of the front bar end 3 via the fork 4 and in front of its rear bar end 5 with the cantle 6.

As illustrated in FIG. 3 and FIG. 4, the bars 2—in order to achieve an advantageous adaptation to the horse's back—have a curvature 7, 33 and also a contortion 8 along their centerline 9 in longitudinal direction 12. In the language of the art, curvature 7, 33 is referred to as rock and contortion 8 as twist.

As is evident from FIG. 4, which is derived from the profile of the FIG. 3 along IV-IV, the bars 2 are each positively curved along their centerline 9 in longitudinal direction 12 from the front bar end 3 up to the rear attachment 10 of fork 4. Then up to the front attachment 11 of cantle 6, the shape in the illustrated exemplary embodiment is free of curvature. Nevertheless, a negative curvature in this region is also conceivable. The further course of the bars 2 is then positively curved up to the rear bar end 5.

In general, it is pointed out that, with view toward the centerline 9 of the rear attachment 10 of fork 4, it is possible to relate to a point of intersection that is obtained when a plane that is perpendicular to the longitudinal axis of the saddle tree and that includes the two front attachments of the fork 4 to the two bars 2 is intersected by the centerline 9. As shown in FIG. 2, this plane corresponds to the straight region between the two reference numerals 10 and therefore does not follow the bent region 37 of the fork 4.

In general, it is further pointed out that, with view toward the centerline 9 of the front attachment 11 of cantle 6, it is possible to relate to a point of intersection that is obtained when a plane that is perpendicular to the longitudinal axis of the saddle tree and that includes the two front attachments 11 of the cantle 6 to the two bars 2 is intersected by the centerline 9. As shown in FIG. 2, this plane is indicated in the connection of the two reference numerals 11 shown as dashed lines.

A saddle tree 1 with rock configured in this way transmits the load of the rider optimally to the horse's back—since this is oriented almost horizontally in the sitting region of the rider during collected motion—during collected motion of the horse. Thus the straight or even negatively curved shape of the bars 2 between attachment 10, 11 of fork 4 and cantle 6 in longitudinal direction 12 represents a particularly favorable adaptation to the horse's back during collected motion. A distribution of the weight of the rider over the surface of the horse's back is achieved by this type of curvature 7, 33. The curvatures 7, 33 at the bar ends 3, 5 permit a good shoulder freedom at the front end as viewed toward the horse's head and a good adaptation at the other rear end of the bars 2 in the region of the end of the thoracic spine. The saddle tree 1 for Western riding according to the invention offers both a weight distribution of the rider over a surface and an adequate shoulder freedom of the horse during riding.

For the description of the type of curvature, the point on the centerline 9 of the bars 2 that is closest to the frontmost outer point of the cantle 6 is understood as the front attachment 11 of the cantle 6. Likewise the rear attachment 10 of the fork 4 is located on the imaginary straight connection of the two rear, outer points of the fork 4. Thus, despite the theoretical shape 37 of the end of the fork turned toward the rider as shown in FIG. 1, the attachment 10 of the fork 4 is at the same position.

As illustrated in FIG. 4, the curvature 7 from the front bar end 3 up to the rear attachment 10 of fork 4 has a steadily increasing radius of curvature 25, 26, 27. Even in the case of an overlapping of the front ends of the bars 3 with the shoulder region, therefore, the necessary freedom of movement of the shoulder exists, since it slides under the saddle tree 1 during motion. Thus the motion of the horse is not hindered or even blocked with such a saddle tree 1. Likewise the curvature 33 from the front cantle attachment 11 up to the bar end 5 has a steadily decreasing radius of curvature 34, 35, 36. 2. A good adaptation in the region of the end of the thoracic spine is achieved in this way.

FIG. 5 shows a side view of the saddle tree 1 with flexible tightening element 14, designed as strap 13, for attachment to a saddle cinch 15. The complete saddle tree 1 accordingly has two flexible tightening elements 14. These are fastened to the respective bar 2 in the front and rear bar region 21, 22. For attachment to a saddle cinch 15, a fastening element 16 is loosely mounted on the tightening element 14. Simple fastening of the saddle by means of the saddle tree 1 is achieved in this way.

The flexible tightening element 14 constructed as strap 13 runs with its top edge 24 up to the front attachment 28 of fork 4. At the other end of the flexible tightening element, this runs with its bottom edge up to the front attachment 11 of the cantle 6. In the interaction with the loose mounting of the fastening element 16, the position for the cinching of the saddle is adjusted in such a way that the fastening element 16 comes to lie under the rear attachment 10 of the fork 4. An advantageous transmission of the rider's weight to the horse is achieved in this way.

The flexible tightening elements 14 are fastened at their ends 17 in the region of the front attachment 28 of fork 4 and at the other end 18 in the region of the front attachment 11 of cantle 6. This permits constructive simplifications in the fastening and guidance of the flexible tightening elements 14 as well as an improved load distribution of the rider's weight. In the illustrated example of FIG. 5, the fastening is achieved with a row of screws 31.

On the basis of this arrangement, at least part of the fastening element 16 is disposed vertically underneath the rear attachment 10 of the fork 4, which improves the uniform transmission of the rider's weight to the horse.

According to FIG. 5, a D-ring 19 with an additional web 20 is used as fastening element 16. Therein the strap 13 passes through the slot 29 between flat part of the D-ring 19 and web 20. Thus the fastening element 16 can be displaced along the flexible tightening element 14 for flexible cinching of the saddle, while twisting of tightening element 14 or D-ring 19 is prevented by virtue of the guidance between flat part of the D-ring 19 and web 20.

In the case of the correct matching of D-ring 19 and length of the strap 13, the D-ring 19 is still disposed with its web 20 above the bottom edge of the skirt 30 when the saddle is in place. Accordingly, the D-ring 19 projects only partly beyond the skirt 30, shown as a dashed line in FIG. 5.

1. Saddle tree for a saddle, especially Western saddle, with a fork, a cantle and with two rigid bars, which are joined to one another via fork and cantle and each of which has not only at least one positive curvature, but also a twist on the underside along its centerline in longitudinal direction characterized in that the bars are each positively curved along their centerline in longitudinal direction from the front bar end to the rear attachment of fork then are curvature-free or negatively curved up to the front attachment of cantle and then are positively curved up to the rear bar end.

2. Saddle tree according to claim 1, wherein the curvature from the front bar end to the rear attachment of fork has a steadily increasing radius of curvature.

3. Saddle tree according to claim 1, wherein the curvature from the front attachment of cantle up to the rear bar end has a steadily decreasing radius of curvature.

4. Saddle tree according to claim 1, wherein it has two flexible tightening elements, especially straps, which are respectively fastened to a bar in its front and rear bar region and each of which carries a fastening element loosely mounted on the respective tightening element for attachment to a saddle cinch.

5. Saddle tree according to claim 4, wherein the top edge of the flexible tightening element runs up to the front attachment of fork and the bottom edge runs up to the front attachment of cantle.

6. Saddle tree according to claim 4, wherein the flexible tightening elements are fastened on the bar at its end in the region of the front attachment of fork and its other end in the region of the front attachment of cantle.

7. Saddle tree according to claim 4, wherein at least part of the fastening element is located vertically underneath the rear attachment of fork.

8. Saddle tree according to claim 4, wherein a D-ring forms the fastening element.

9. Saddle tree according to claim 8, wherein the D-ring has a web wherein the D-ring forms a slot for passing the respective flexible tightening element between its flat part and the web.

10. Saddle with a saddle tree according to claim 1.

11. Saddle according to claim 10 with a skirt, wherein the web of the D-ring projecting in part from the skirt is disposed above the bottom edge of the skirt.

12. Saddle according to claim 10 with a saddle cinch, which is attached to the fastening element.
